(19) United States
(12) Patent Application Publication
(10) Pub. No.: US 2025/0353170 A1
(43) Pub. Date: Nov. 20, 2025

(54) ROBOT SYSTEM AND ROBOT CONTROL DEVICE

(71) Applicant: FANUC CORPORATION, Yamanashi (JP)

(72) Inventor: Wanfeng FU, Yamanashi (JP)

(21) Appl. No.: 18/873,331

(22) PCT Filed: Jul. 6, 2022
(86) PCT No.: PCT/JP2022/026852

§ 371 Date: Dec. 10, 2024

(51) Int. Cl. B25J 9/16; B25J 9/00; B25J 13/08

(52) U.S. Cl. CPC B25J 9/1633; B25J 9/0093; B25J 9/1697; B25J 13/085

(57) ABSTRACT

Provided is a robot system that comprises a robot, a robot control device which executes a robot program and controls the robot, and a force detection unit which detects a force acting on the robot. The robot control device comprises: a determination unit that, on the basis of the robot program, determines an operating mode for force control, using the force detection unit, executed by the robot program; and a force control setting unit that sets operation settings for force control in accordance with the operating mode for the force control determined by the determination unit.

### FIELD

The present invention relates to a robot system and a robot controller.

### BACKGROUND

A robot system in which a robot is controlled to perform predetermined work while tracking a workpiece conveyed on a conveyance device is known.

PTL 1 describes a robot system including a robot 100, an end effector 200, a robot controller 300, a camera 400, and a conveyance device 500 (Paragraph 0033). PTL 1 also describes as follows: “A control signal generation unit 310 generates a position control signal indicating a target position where the end effector 200 is to be positioned and outputs the signal to a position control unit 320. When receiving an instruction to perform tracking control from a user, the control signal generation unit 310 outputs a signal indicating that tracking control is to be performed to the position control unit 320. When receiving an instruction to perform force control from the user, the control signal generation unit 310 outputs a control signal indicating that force control is to be performed to the position control unit 320.” (Paragraph 0042).

PTL 2 describes as follows: “A control method for a robot 1 performing work on a target object W conveyed by a conveyance device 50 by using an end effector 20, the method including: calculating a target position of the end effector 20 based on a position of the target object W; calculating an amount of tracking correction for correcting the target position in accordance with an amount of conveyance of the target object W; causing the end effector 20 to follow the target object W based on the target position and the amount of tracking correction; acquiring an acting force acting on the end effector 20 from the target object W by using a force sensor P; calculating an amount of force control correction for correcting the target position so that the acting force is equal to a target force; and controlling the acting force to be a predetermined target force by driving a manipulator 10 based on the amount of force control correction.” (ABSTRACT).

### CITATION LIST

### Patent Literature

[PTL 1] Japanese Unexamined Patent Publication (Kokai) No. 2018-171665 A
[PTL 2] Japanese Unexamined Patent Publication (Kokai) No. 2020-189392 A

### SUMMARY

### Technical Problem

When an operator creates a robot program for controlling a robot to perform work by using force control while tracking a workpiece conveyed on a conveyance device, the operator needs to add, to the robot program, statements defining an operation mode of force control before and after an instruction for calling force control. Such programming work is troublesome and may cause a human error such as missetting. A robot system and a robot controller that enable automatic setting of the operation mode of force control are desired.

### Solution to Problem

An aspect of the present disclosure is a robot system including: a robot; a robot controller configured to execute a robot program and control the robot; and a force detection unit configured to detect a force acting on the robot, wherein the robot controller includes: a determination unit configured to determine, based on the robot program, an operation mode of force control using the force detection unit, the force control being executed in the robot program; and a force control setting unit configured to perform setting of the force control according to the operation mode of the force control determined by the determination unit.

Another aspect of the present disclosure is a robot controller for executing a robot program and controlling a robot, the robot controller including: a determination unit configured to determine, based on the robot program, an operation mode of force control using a force detection unit, the force control being executed in the robot program; and a force control setting unit configured to performing setting of the force control according to the operation mode of the force control determined by the determination unit.

### Advantageous Effects of Invention

The aforementioned configurations enable automatic determination of an operation mode of force control and automatic operation setting of force control.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system according to an embodiment.

FIG. 2 is a functional configuration diagram of the robot system.

FIG. 3 is a flowchart illustrating determination processing of the operation mode of force control.

FIG. 4 is a conceptual diagram illustrating association between a robot program and a tracking schedule.

FIG. 5 is an example of a confirmation screen of association between a robot program and a tracking schedule.

FIG. 6 is a diagram for illustrating a setting example of a work area.

FIG. 7 is a diagram illustrating an example of automatic setting of a work area.

FIG. 8 is a diagram for illustrating an example of re-setting a work area by excluding an obstacle.

FIG. 9 is a diagram for illustrating detection of a state of the robot departing from a work area.

FIG. 10 is a flowchart illustrating a flow of processing including setting of a force control mode and setting and monitoring of an area.

### DESCRIPTION OF EMBODIMENTS

Next, embodiments of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

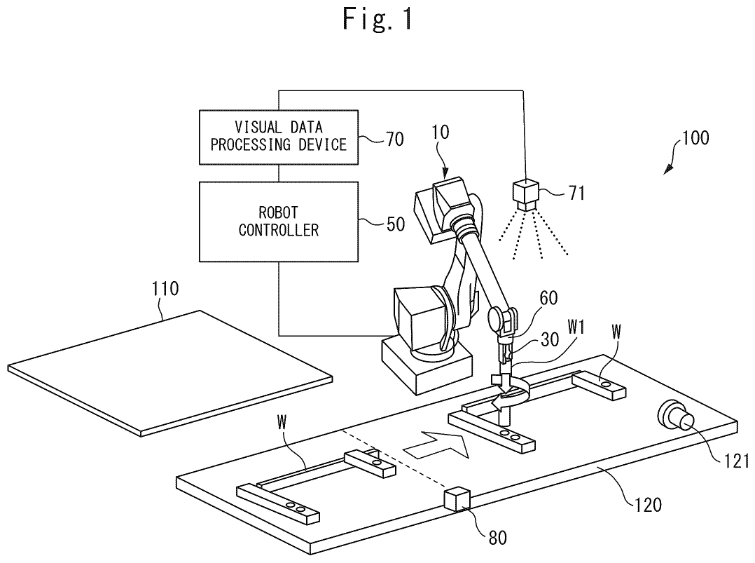

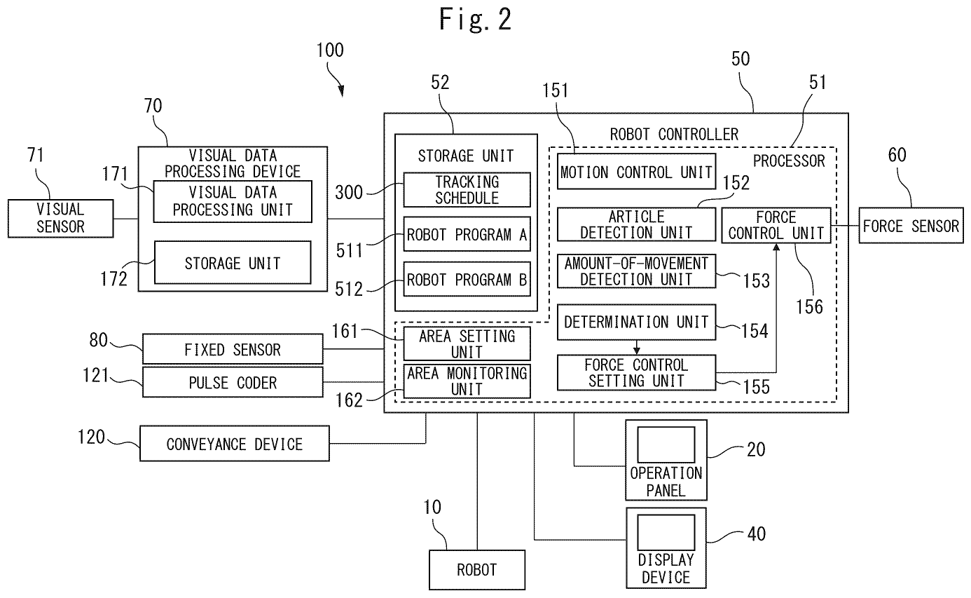

FIG. 1 is a diagram illustrating a configuration of a robot system 100 according to an embodiment. As illustrated in FIG. 1, the robot system 100 includes a conveyance device 120 conveying a workpiece, a robot 10, a robot controller 50 controlling the robot 10, a visual sensor 71, and a visual data processing device 70 controlling the visual sensor 71. The visual data processing device 70 is connected to the robot controller 50. The conveyance device 120 includes a pulse coder 121 as a sensor for detecting an amount of movement of a workpiece by the conveyance device 120. For example, the visual sensor 71 is fixed to a workspace and serves to monitor a work area, etc. A fixed sensor 80 for detecting a workpiece is arranged on the conveyance device 120. For example, the fixed sensor 80 may be a sensor including a light-emitting unit and a light-receiving unit and detecting a target object passing between the light-emitting unit and the light-receiving unit. It should be noted that part of components constituting the robot system 100 (an operation panel 20 and a display device 40 (see FIG. 2)) are omitted in FIG. 1.

The robot 10 can execute desired work with an end effector attached to the wrist of the arm tip. The end effector is an external device exchangeable according to the purpose and is, for example, a hand, a welding gun, or a tool. FIG. 1 illustrates an example of using a hand 30 as the end effector.

A force sensor 60 as a force detection unit detecting a force (external force) acting on the robot 10 is provided between the hand 30 as a work tool and the arm tip (flange) on the robot 10. For example, the force sensor 60 is a six-axis force sensor detecting the forces acting on the work tool in directions of three axes being an X-axis, a Y-axis, and a Z-axis and the moment around each of the X-axis, the Y-axis, and the Z-axis. In other words, the force sensor 60 can detect the force and the moment generated by contact between a part or the work tool held by the robot 10, and an article. Another type of force detector (such as a torque sensor arranged at each axis of the robot) may be used for detecting the force acting on the robot 10.

The robot 10 in the robot system 100 can execute predetermined work by using force control while tracking a workpiece flowing on the conveyance device 120. FIG. 1 illustrates an example of performing work of fitting a workpiece WI as a part held by the robot 10 into a hole in a workpiece W flowing on the conveyance device 120.

Further, a fixed workbench 110 is provided in the robot system 100. The robot 10 (robot controller 50) can also perform work on a workpiece placed on the fixed workbench in a regular force control mode.

The robot system 100 according to the present embodiment is configured to be able to automatically determine which of the mode of force control executed during tracking operation and the regular force control mode is to be applied, based on a robot program, and perform mode setting of force control.

FIG. 2 is a functional configuration diagram of the robot system 100. The robot controller 50 may have a configuration as a common computer including a processor 51, a storage unit (memory) 52, unillustrated various input-output interfaces, an unillustrated operation unit, etc. as hardware components. FIG. 2 illustrates functional blocks provided by executing software by the processor 51. As illustrated in FIG. 2, the robot controller 50 includes a motion control unit 151, an article detection unit 152, an amount-of-movement detection unit 153, a determination unit 154, a force control setting unit 155, and a force control unit 156.

A robot program for controlling the robot 10 to execute predetermined work and a tracking schedule 300 including setting information related to the tracking operation, wherein the setting information is applied when the robot 10 is controlled to perform work while tracking a workpiece flowing on the conveyance device 120, are registered in the storage unit 52.

The robot program registered in the storage unit 52 includes a robot program A for performing predetermined work by using force control while causing the robot 10 to perform the tracking operation and a robot program B for performing, on the fixed workbench 110, predetermined work by using force control without the tracking operation.

The motion control unit 151 controls the motion of the robot 10 in accordance with the robot program. For example, the article detection unit 152 can detect a timing at which a workpiece conveyed on the conveyance device 120 enters a work area, based on a signal from the fixed sensor 80. The amount-of-movement detection unit 153 can determine an amount of movement by which the robot 10 is moved during the tracking operation, based on a signal from the pulse coder 121. Other than the technique of using a signal from the pulse coder 121, a technique of detecting an amount of movement of a workpiece conveyed on the conveyance device 120 by a visual sensor may be employed as a technique for detecting an amount of movement of the workpiece. For example, a technique of determining an amount of movement of a workpiece being conveyed by capturing movement of the workpiece with a camera mounted on the tip of the robot 10 may also be employed.

Based on a detection timing of a workpiece acquired by the article detection unit 152, information about an amount of movement of the workpiece acquired by the amount-of-movement detection unit 153, etc., the motion control unit 151 can execute predetermined work on the workpiece by applying force control while tracking the workpiece flowing on the conveyance device 120.

The determination unit 154 automatically determines, based on a robot program to be executed, whether the robot program applies an operation mode of performing force control while performing tracking operation or an operation mode of performing regular force control.

The force control setting unit 155 switches the operation mode of force control between the mode of force control executed during tracking operation and the regular force control mode according to a determination result by the determination unit 154. Since the workpiece WI comes in contact with the workpiece W during a motion of fitting the workpiece WI into the workpiece W by the robot 10 in the force control during the tracking operation, the robot 10 is considered to be likely to produce a vibration motion. In view of the above, as an example, a setting parameter related to filtering for reducing the vibration of the robot 10 is included in the force control during the tracking operation. Thus, the force control setting unit 155 sets a different force control parameter between the regular force control mode and the mode of force control during tracking operation.

The force control unit 156 executes force control using the force sensor 60 in accordance with force control parameters set by the force control setting unit 155.

The visual data processing device 70 may also have a configuration as a computer including a processor, a memory, etc. As illustrated in FIG. 2, the visual data processing device 70 includes a visual data processing unit 171 and a storage unit 172. The visual data processing unit 171 can provide a function of performing various types of image processing for detection and monitoring of an object, based on an image captured by the visual sensor 71. For example, the visual data processing unit 171 can provide a function of detecting a target object in an image, based on model data of the target object. The position of the robot 10 when the robot 10 performs work on a workpiece W may be controlled to be corrected by using the detection function of the workpiece W by the visual sensor 71 (visual data processing device 70).

The storage unit 172 stores calibration data of the visual sensor 71 and various types of setting information required in execution of image processing.

As illustrated in FIG. 2, the robot controller 50 may be further connected to the operation panel 20 for performing input of an instruction and output of various types of information to and from the robot controller 50. The robot controller 50 may be further connected to the display device 40 for displaying various types of information about work executed by the robot 10.

The way in which the determination unit 154 determines whether the operation mode of the force control is the force control during the tracking operation or the regular force control will be described. When a robot program actuating the conveyance device 120 and causing the robot to perform the tracking operation is created, setting data including various types of setting information related to the tracking operation (referred to as a tracking schedule) are prepared. For example, an operator may input setting parameters of the tracking schedule through a user interface (UI) screen. Such a UI screen may be presented on a display unit of the operation panel 20. For example, parameters of the tracking schedule may include the following contents.
a tracking schedule number
a tracking type
a reference coordinate system for tracking
a tracking direction
an encoder used for tracking
a scale factor of the encoder
   The “tracking schedule number” represents the number of tracking schedule data. When a plurality of tracking schedules are prepared, each schedule can be identified by the number. The “tracking type” is used to specify the type of motion (such as a linear motion or an arc-shaped motion) of the tracking operation. The “reference coordinate system for tracking” specifies a reference coordinate system used when tracking of a target object is performed. The “direction of tracking” specifies a direction in which tracking is performed. The “encoder used for tracking” specifies an identification number of an encoder as an amount-of-movement detector used in tracking. The “scale factor of the encoder” specifies a relation between a pulse count of the encoder and a moving distance of the conveyance device.

A robot program for controlling a robot to execute work while tracking a workpiece refers to such a tracking schedule. FIG. 4 illustrates, as a conceptual diagram, a situation where a tracking schedule 301 is referred to by a robot program 501 for controlling the robot to execute work while tracking a workpiece. For example, the robot program 501 may be configured to refer to the tracking schedule 301 through a statement for allowing data in the tracking schedule 301 to be referenceable from the robot program 501 (such as a define statement importing the tracking schedule data into a variable).

Thus, the robot program 501 including the tracking operation is associated with the tracking schedule 301. The determination unit 154 determines whether the operation mode of force control in the robot program is an operation mode of force control executed with tracking operation or an operation mode of the regular force control, based on whether the robot program is associated with the tracking schedule.

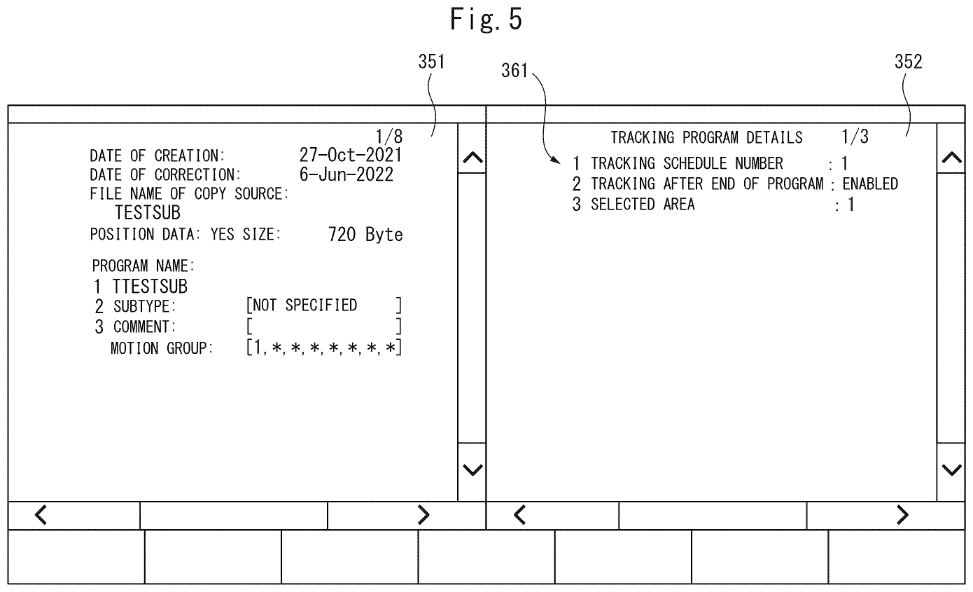

FIG. 5 illustrates an example of a screen when a state where a robot program including tracking operation is associated with a tracking schedule is confirmed. A screen 351 on the left side in FIG. 5 is a screen example of displaying a robot program being a confirmation target. The example illustrates that a program name being a confirmation target is “TTESTSUB.” A screen 352 on the right side in FIG. 5 displays that the number of a tracking schedule referred to by the program “TTESTSUB” is “1” (see a display field with a sign 361).

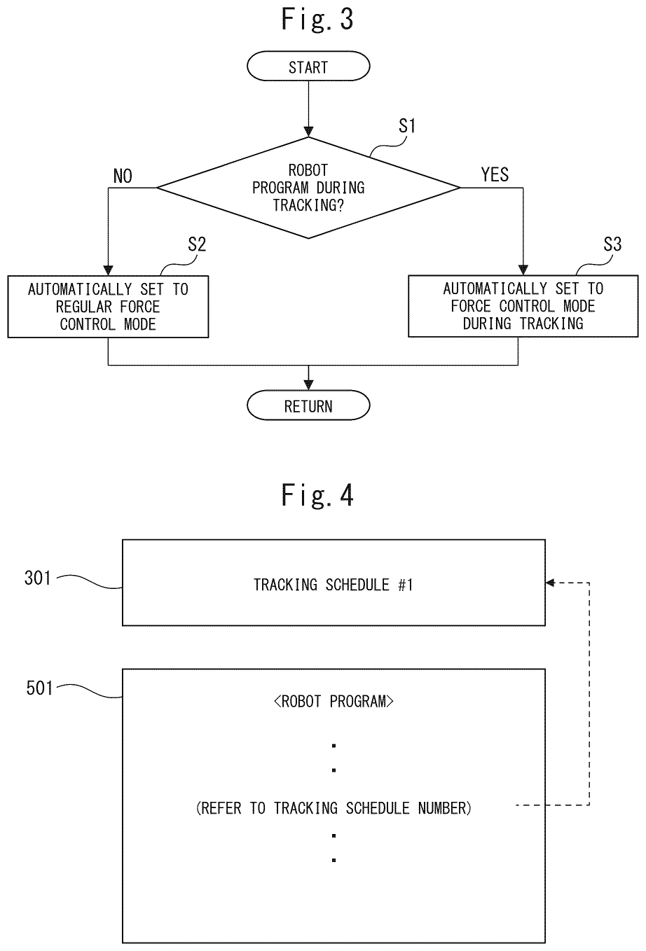

FIG. 3 is a flowchart illustrating determination processing of the operation mode of force control executed by the robot controller 50. First, the determination unit 154 determines whether a robot program is a robot program including the tracking operation, based on whether the robot program is associated with a tracking schedule as described above (step S1). When the robot program is determined not to be a robot program including the tracking operation (S1: NO), the force control setting unit 155 performs automatic setting to the regular force control mode by setting force control parameters for performing the regular force control to the force control unit 156 (step S2). When the robot program is determined to be a robot program including the tracking operation (S1: YES), the force control setting unit 155 performs automatic setting to the mode of force control executed during tracking operation by setting force control parameters for performing the force control during tracking operation to the force control unit 156 (step S3).

Functions for setting and monitoring of a work area of the robot 10 executed by the robot controller 50 will be described below. As illustrated in FIG. 2, the robot controller 50 includes an area setting unit 161 and an area monitoring unit 162.

The area setting unit 161 provides a function for setting an area where the robot 10 is allowed to work. As an example, the area setting unit 161 may be configured to accept a setting input for setting a work area through a user interface (UI) screen. The work area may be defined as an area in a world coordinate system defined in a space where the robot system 100 is arranged. For example, the work area may be defined as an area two-dimensionally extending on a conveyance surface of the conveyance device 120.

The area monitoring unit 162 monitors a work area, based on an image captured by the visual sensor 71, and detects entry of an obstacle into the work area and exit of the robot 10 from the work area. The area monitoring unit 162 can provide a monitoring function by using an image processing function of the visual data processing unit 171. As an example, the area monitoring unit 162 may detect entry of an object into the work area and exit of the robot 10 from the work area by comparison among pixel values of images successively captured by the visual sensor 71. Another object detection method known in the technical field of object detection in an image may be used.

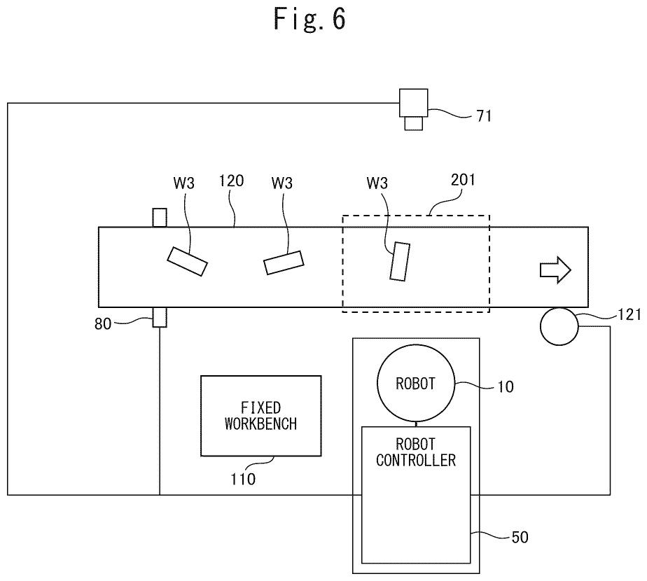

FIG. 6 illustrates a schematic diagram of a state of setting a work area 201 of the robot 10 on the conveyance device 120. The robot 10 can perform predetermined work by force control while tracking a workpiece W3 flowing on the conveyance device 120 and also can perform work on a workpiece on the fixed workbench 110 by the regular force control.

The work area 201 is set on the conveyance device 120 in front of the robot 10. The visual sensor 71 is arranged to be able to capture an image in a range including the work area 201. The area monitoring unit 162 monitors the work area based on an image captured by the visual sensor 71.

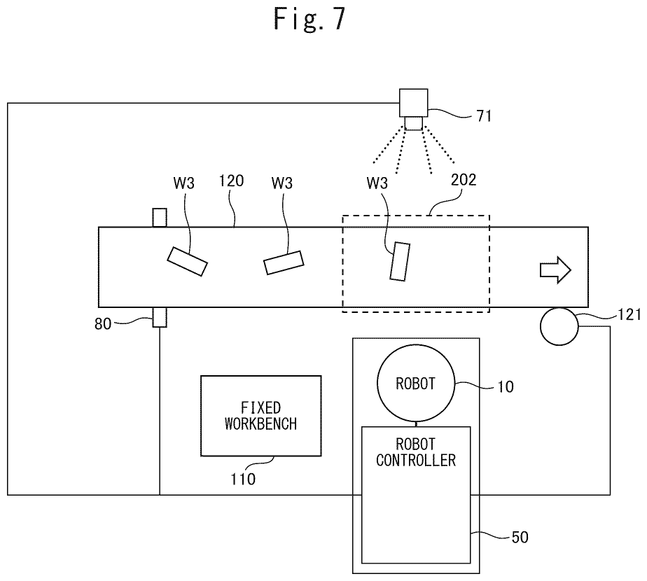

When a work area is not set, the area setting unit 161 may automatically set a work area in the image capture range of the visual sensor 71, based on position information of the visual sensor 71 and the robot 10. For example, a work area 202 as illustrated in FIG. 7 may be automatically set as an area two-dimensionally extending on the conveyance device 120 and in front of the robot 10.

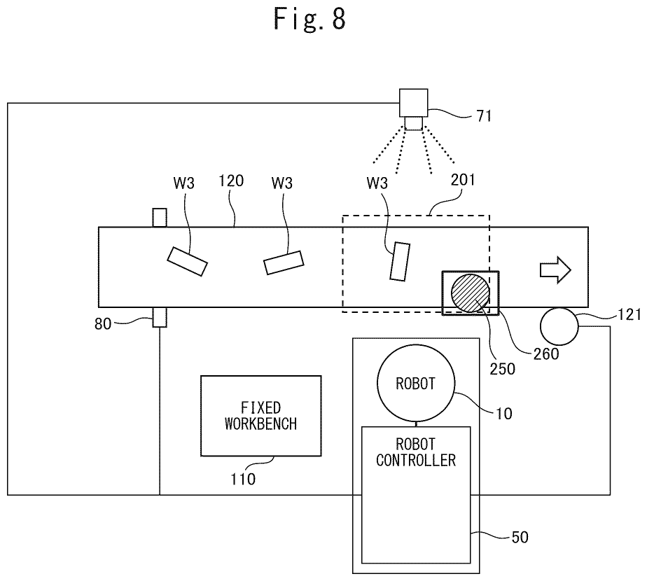

It is assumed as illustrated in FIG. 8 that an obstacle 250 enters the work area 201. In this case, the entry of the obstacle 250 into the work area 201 is detected by the area monitoring unit. For example, the area setting unit may set a rectangular area 260 enclosing the obstacle 250, based on the detection result of the obstacle 250 and re-set a work area in such a way that the area 260 is excluded from the work area 201. Consequently, the area 260 is excluded from the work area where the robot 10 is allowed to move, and interference between the robot 10 and the obstacle 250 can be avoided. Such re-setting of a work area may be performed in real time.

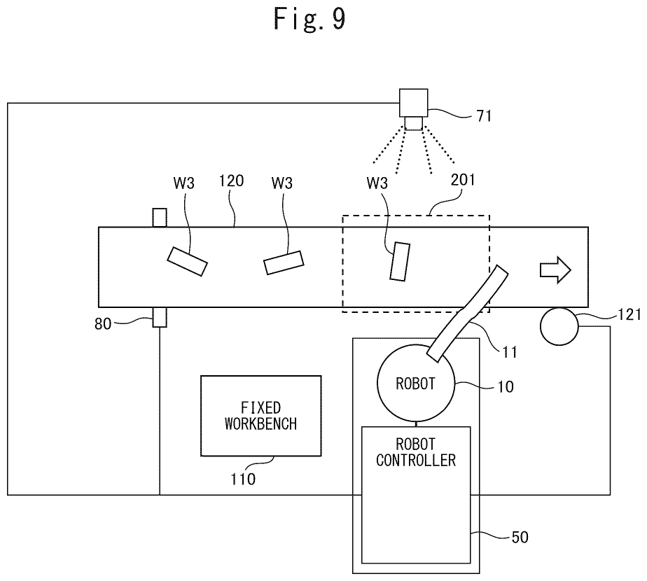

FIG. 9 illustrates a state in which the robot 10 performs a motion of departing from the work area. It is assumed that an arm 11 of the robot 10 departs from the work area 201. The area monitoring unit detects exit of the robot 10 from the work area 201, based on an image from the visual sensor 71. In this case, the motion control unit may discontinue the force control operation by the force control unit and move to processing a next operation instruction. Consequently, occurrence of a situation in which the flow of the entire work stops can be avoided.

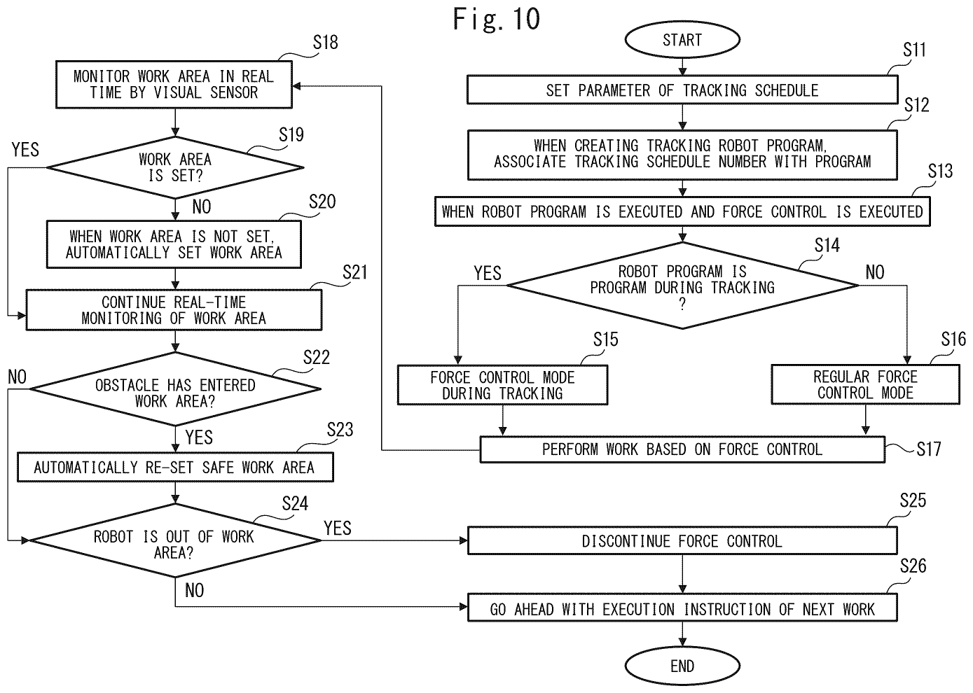

FIG. 10 is a flowchart illustrating a flow of processing including the setting of the force control mode described above and the area setting/monitoring in the robot system 100.

First, for example, an operator performs setting of parameters of a tracking schedule through a UI screen (step S11). Consequently, setting data of the tracking schedule as described above are prepared. Next, the operator creates a robot program including the force control executed with the tracking operation. At this time, the operator associates the robot program with the number of the tracking schedule.

Next, the operator instructs the robot controller to execute the robot program created as described above. When force control is executed in the robot program, whether the robot program is a robot program including the tracking operation is determined by the determination unit 154 (step S14). When the robot program is determined to be a robot program including the tracking operation (S14: YES), the force control setting unit 155 performs setting to the mode of force control executed during tracking operation (step S15). When the robot program is determined not to be a robot program including the tracking operation (S14: NO), the force control setting unit 155 performs setting to the regular force control mode (step S16).

After setting of the force control mode is thus performed, an operation based on force control is executed in accordance with the robot program (step S17).

Next, real-time monitoring of a work area by the visual sensor 71 is performed (step S18). The area setting unit 161 determines whether a work area is set (step S19). When a work area is already set by a user (S19: YES), the processing advances to step S21. When a work area is not set (S19: NO), the area setting unit 161 automatically sets a work area of the robot 10 as described above with reference to FIG. 7 (step S20).

The area monitoring unit 162 continues monitoring of the work area based on an image from the visual sensor 71 (step S12). When the area monitoring unit 162 determines that an obstacle has entered the work area (S22: YES), the area setting unit 161 performs re-setting of a safe work area in such a way that the obstacle area is excluded as described with reference to FIG. 8 (step S23).

Next, the area monitoring unit 162 determines whether the robot 10 is out of the work area (step S24). When the robot 10 is determined to be out of the work area (S24: YES), the motion control unit 151 discontinues the force control operation being currently executed (step S25) and executes an instruction for next work (step S26). On the other hand, when the robot 10 is determined not to be out of the work area (S24: NO), the motion control unit 151 goes ahead with execution of an instruction for next work normally (step S26).

Thus, according to the present embodiment, it is possible to determine whether a robot program is a robot program including the tracking operation, and to automatically and suitably set the operation mode of force control. In other words, the present embodiment enables automatic determination of the operation mode of force control and automatic setting of the force control.

While the present invention has been described above by using the typical embodiments, it may be understood by a person skilled in the art that changes, and various other changes, omissions, and additions can be made to the aforementioned embodiments without departing from the scope of the present invention.

Arrangement of the functional blocks in the functional block diagram illustrated in FIG. 2 is an example, and there may be various modified examples regarding arrangement of the functions. For example, the function of the visual data processing device 70 may be provided in the robot controller 50.

While whether the operation mode of force control is the operation mode of performing the force control during tracking operation or the operation mode of the regular force control is determined based on a robot program, according to the aforementioned embodiment, the present invention is not limited to such a determination example. The operation mode of force control may be determined based on various types of information acquired from a robot program or various types of data associated with the robot program, and the operation mode of the force control may be automatically changed by changing setting parameters of the force control according to the determination result.

Each of the operation panel 20 and the display device 40 may have a configuration as a common computer including a CPU, a ROM, a RAM, a storage device, an operation unit, a display unit, an input-output interface, a network interface, etc.

A program executing the determination processing illustrated in FIG. 3 and various types of processing described in FIG. 10 can be recorded on various computer-readable recording media (such as semiconductor memories such as a ROM, an EEPROM, and a flash memory; a magnetic recording medium; and optical disks such as a CD-ROM and a DVD-ROM).

### REFERENCE SIGNS LIST

10 Robot
11 Arm
20 Operation panel
30 Hand
40 Display device
50 Robot controller
51 Processor
52 Storage unit
60 Force sensor
70 Visual data processing device
71 Visual sensor
80 Fixed sensor
100 Robot system
151 Motion control unit
152 Article detection unit
153 Amount-of-movement detection unit
154 Determination unit
155 Force control setting unit
156 Force control unit
161 Area setting unit
162 Area monitoring unit
171 Visual data processing unit
172 Storage unit
110 Fixed workbench
120 Conveyance device
121 Pulse coder
201, 202 Work area
300, 301 Tracking schedule

1. A robot system comprising:
a robot;
a robot controller configured to execute a robot program and control the robot; and
a force detection unit configured to detect a force acting on the robot, wherein
the robot controller includes:
a determination unit configured to determine, based on the robot program, an operation mode of force control using the force detection unit, the force control being executed in the robot program; and
a force control setting unit configured to perform setting of the force control according to the operation mode of the force control determined by the determination unit.

2. The robot system according to claim 1, further comprising
a conveyance device, wherein
the determination unit determines, based on the robot program, whether the operation mode of the force control is an operation mode of executing force control while tracking an article conveyed on the conveyance device or an operation mode of regular force control executed without tracking an article.

3. The robot system according to claim 2, wherein
the determination unit determines whether the operation mode of the force control is an operation mode executing force control while tracking an article or an operation mode of regular force control by determining whether the robot program is associated with setting data relating to tracking operation.

4. The robot system according to claim 1, wherein
the force control setting unit automatically sets a force control parameter according to the determined operation mode of the force control.

5. The robot system according to claim 1, further comprising
a visual sensor, wherein
the robot controller further includes an area setting unit configured to perform setting relating to a work area of the robot as a monitoring target by the visual sensor.

6. The robot system according to claim 5, wherein,
when the work area is not set, the area setting unit sets the work area in an image capture range of the visual sensor, based on position information of the visual sensor and the robot.

7. The robot system according to claim 5, wherein
the robot controller further includes an area monitoring unit configured to detect entry of an obstacle into the work area, based on an image captured by the visual sensor, and
the area setting unit performs re-setting of the work area in such a way that an area where the obstacle exists in the work area is excluded from the work area.

8. The robot system according to claim 5, wherein
the robot controller further includes an area monitoring unit configured to perform control in such a way as to discontinue the force control when the robot is out of the work area.

9. A robot controller for executing a robot program and controlling a robot, the robot controller comprising:
a determination unit configured to determine, based on the robot program, an operation mode of force control using a force detection unit, the force control being executed in the robot program; and
a force control setting unit configured to perform setting of the force control according to the operation mode of the force control determined by the determination unit.

10. The robot controller according to claim 9, wherein
the determination unit determines, based on the robot program, whether the operation mode of the force control is an operation mode of executing force control while tracking an article conveyed on a conveyance device or an operation mode of regular force control executed without tracking an article.

11. The robot controller according to claim 10, wherein
the determination unit determines whether the operation mode of the force control is an operation mode executing force control while tracking an article or an operation mode of regular force control by determining whether the robot program is associated with setting data relating to tracking operation.

12. The robot controller according to claim 9, wherein
the force control setting unit automatically sets a force control parameter according to the determined operation mode of the force control.

13. The robot controller according to claim 9, further comprising
an area setting unit configured to perform setting relating to a work area of the robot as a monitoring target by a visual sensor.

14. The robot controller according to claim 13, wherein,
when the work area is not set, the area setting unit sets the work area in an image capture range of the visual sensor, based on position information of the visual sensor and the robot.

15. The robot controller according to claim 13, further comprising
an area monitoring unit configured to detect entry of an obstacle into the work area, based on an image captured by the visual sensor, wherein
the area setting unit performs re-setting of the work area in such a way that an area where the obstacle exists in the work area is excluded from the work area.

16. The robot controller according to claim 13, further comprising
an area monitoring unit configured to perform control in such a way as to discontinue the force control when the robot is out of the work area.
